(19) United States
(12) Patent Application Publication
(10) Pub. No.: US 2025/0172381 A1
(43) Pub. Date: May 29, 2025

(54) DISPLAY INSPECTION APPARATUS OF WAVELENGTH SCAN TYPE

(71) Applicant: KOREA ELECTRONICS TECHNOLOGY INSTITUTE, Seongnam-si (KR)

(72) Inventors: Kyoungwon PARK, Seongnam-si (KR); Jeongno LEE, Seongnam-si (KR); Sungjae PARK, Seongnam-si (KR)

(21) Appl. No.: 18/953,205

(22) Filed: Nov. 20, 2024

(30) Foreign Application Priority Data
Nov. 23, 2023 (KR) 10-2023-0164150
Jul. 2, 2024 (KR) 10-2024-0086565

(51) Int. Cl. G01B 11/06

(52) U.S. Cl. CPC G01B 11/06

(57) ABSTRACT

In an embodiment, a display inspection apparatus of a wavelength scan type includes a display sample having one or more layers; a light irradiator irradiating light to the display sample so that the light is incident onto a two-dimensional area of a surface of the display sample; a filter wheel having a plurality of filters, each filter converting reflected light reflected from the display sample into wavelength-reflected light with a corresponding wavelength; a driver rotating the filter wheel; a spectrometer measuring a spectrum for the wavelength-reflected light; and a controller controlling the driver to change the filter through which the reflected light passes, and determining a thickness of each of the one or more layers based on the spectrum for the two-dimensional area over a plurality of wavelengths according to the change of the filter.

### CROSS-REFERENCE TO RELATED APPLICATION(S)

This application is based on and claims priority under 35 U.S.C. 119 to Korean Patent Application No. 10-2023-0164150 filed on Nov. 23, 2023, and Korean Patent Application No. 10-2024-0086565 filed on Jul. 2, 2024, in the Korean Intellectual Property Office, the disclosures of which are herein incorporated by reference in their entireties.

### BACKGROUND

### Field

The disclosure relates to a display inspection apparatus of a wavelength scan type, and more particularly, to a wavelength scan type display inspection apparatus capable of inspecting a thin film of a display, such as an Organic Light Emitting Diode (OLED) and a Quantum dot Light Emitting Diode (QLED), which are manufactured by an inkjet printing method.

### Description of Related Art

Recently, as displays are widely applied to mobile phones, computers, and automobiles, the need for a display inspection apparatus capable of quickly inspecting thin films of displays in a manufacturing process of such displays is increasing.

FIG. 1A is a front view illustrating ellipsometry used in a typical apparatus for measuring a thin film thickness, and FIG. 1B is a perspective view illustrating a problem of ellipsometry used in a typical apparatus for measuring a thin film thickness.

With reference to FIG. 1A, in ellipsometry used in a typical apparatus for measuring a thin film thickness, a light source 10 irradiates light L onto a surface of a thin film sample S′ so that the light L is incident onto the surface of the thin film sample S′ at a predetermined angle θ with respect to the normal line V, and a detector 20 receives the reflected light Lr reflected from the thin film sample S′. Based on the spectrum of the reflected light Lr received in this manner, the thickness of the thin film sample S′ is measured.

With reference to FIG. 1B, in the case where such ellipsometry is used to measure the thickness of a thin film TL of a sub-pixel RSP of a display sample S manufactured as a display such as OLED or QLED using inkjet printing, there is a problem in that it is difficult to inspect the thickness of the thin film of the display sample S because the light L irradiated from the light source 10 is blocked by a partition wall B1 (also referred to as a Pixel Define Layer (PDL)) or, even if the light L is incident onto the thin film TL of the pixel P and reflected, the reflected light is blocked by a partition wall B2.

In addition, a contact-type thickness measurement inspection apparatus such as an Atomic Force Microscope (AFM), a Scanning Probe Microscope (SPM), a Scanning Tunneling Microscope (STM), or a surface profiler has a problem of impossible real-time inspection due to a long time in measurement and a problem of causing destruction of the thin film.

Korean Patent No. 10-2531420 entitled “apparatus and method for inspecting display” has been disclosed. This patent document shows that the predictability of the thickness of a thin film can be further improved by using a machine learning technique. However, this display inspection apparatus uses a line scan method. That is, only information about lines can be measured, and since image information about a two-dimensional area is constructed through line scanning, there is a problem that the measurement time increases.

### SUMMARY

The disclosure is intended to provide a wavelength scan type display inspection apparatus capable of rapidly measuring the thickness of a thin film of a display sample in a nanometer level.

In addition, the disclosure is intended to provide a wavelength scan type display inspection apparatus capable of predicting the thickness of each layer of OLED and QLED devices manufactured by an inkjet printing method with a single measurement and capable of determining defects due to thickness unevenness and improving the defects through related feedback.

Furthermore, the disclosure is intended to provide a wavelength scan type display inspection apparatus capable of not only reducing the measurement time but also minimizing the prediction error for the thickness of each layer.

According to the first feature of embodiments of the disclosure, a display inspection apparatus of a wavelength scan type may include a display sample having one or more layers; a light irradiator irradiating light to the display sample so that the light is incident onto a two-dimensional area of a surface of the display sample; a filter wheel having a plurality of filters, each filter converting reflected light reflected from the display sample into wavelength-reflected light with a corresponding wavelength; a driver rotating the filter wheel; a spectrometer measuring a spectrum for the wavelength-reflected light; and a controller controlling the driver to change the filter through which the reflected light passes, and determining a thickness of each of the one or more layers based on the spectrum for the two-dimensional area over a plurality of wavelengths according to the change of the filter.

In the apparatus according to the first feature, the controller may determine the thickness of each of the one or more layers by using artificial intelligence.

In the apparatus according to the first feature, the artificial intelligence may include one or more of random forest, Gaussian process regression, and deep learning neural network.

According to the second feature of embodiments of the disclosure, a display inspection apparatus of a wavelength scan type may include a display sample having one or more layers; a light irradiator irradiating light to the display sample so that the light is incident onto a two-dimensional area of a surface of the display sample, and including a light source generating the light; a spectrometer measuring a spectrum for reflected light reflected from the display sample; and a controller controlling the light source to change a wavelength of the light, and determining a thickness of each of the one or more layers based on the spectrum for the two-dimensional area over a plurality of wavelengths according to the change in the wavelength of the light.

In the apparatus according to the second feature, the controller may determine the thickness of each of the one or more layers by using artificial intelligence.

In the apparatus according to the second feature, the artificial intelligence may include one or more of random forest, Gaussian process regression, and deep learning neural network.

The display inspection apparatus of the wavelength scan type according to embodiment of the disclosure achieves the following effects.
1. The thickness of a thin film of a display sample can be measured in a nanometer level in a short time.
2. The thickness of each layer of OLED and QLED devices manufactured by an inkjet printing method can be predicted with a single measurement, and it is possible to determine defects due to thickness unevenness and improve the defects through related feedback.
3. The measurement time can be reduced, and the prediction error for the thickness of each layer can be minimized.

### BRIEF DESCRIPTION OF THE DRAWINGS

In the drawings, the same or similar reference numerals may be used to indicate the same or similar elements.

FIG. 1A is a front view illustrating ellipsometry used in a typical apparatus for measuring a thin film thickness.

FIG. 1B is a perspective view illustrating a problem of ellipsometry used in a typical apparatus for measuring a thin film thickness.

FIG. 2 is a front view of a wavelength scan type display inspection apparatus according to an embodiment of the disclosure.

FIG. 3 is a conceptual diagram illustrating a wavelength scan type display inspection apparatus according to an embodiment of the disclosure.

FIG. 4 is a conceptual diagram illustrating a line scan type display inspection apparatus according to a comparative example.

FIGS. 5 and 6 are plan views illustrating a two-dimensional area of a display sample.

FIG. 7 is a cross-sectional view of a pixel of a display sample.

FIG. 8 is a graph showing the relationship between the number of filters and a relative error for a simulation of measuring the thickness of each layer of a display sample by a wavelength scan type display inspection apparatus according to an embodiment of the disclosure.

FIG. 9 is a graph showing the relationship between the number of estimators and a relative error for a simulation of measuring the thickness of each layer of a display sample by a wavelength scan type display inspection apparatus according to an embodiment of the disclosure.

FIG. 10 is a front view of a wavelength scan type display inspection apparatus according to a modified embodiment of the disclosure.

FIG. 11 is a graph showing the relationship between an actual layer thickness and a predicted layer thickness for the results of actually inspecting the layer thickness of a display sample having a single layer by a wavelength scan type display inspection apparatus according to a modified embodiment of the disclosure.

FIGS. 12 and 13 are graphs showing the relationship between an actual layer thickness and a predicted layer thickness for the results of actually inspecting each layer thickness of a display sample having two layers by a wavelength scan type display inspection apparatus according to a modified embodiment of the disclosure.

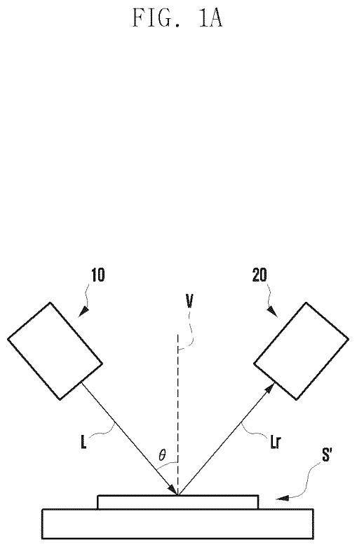

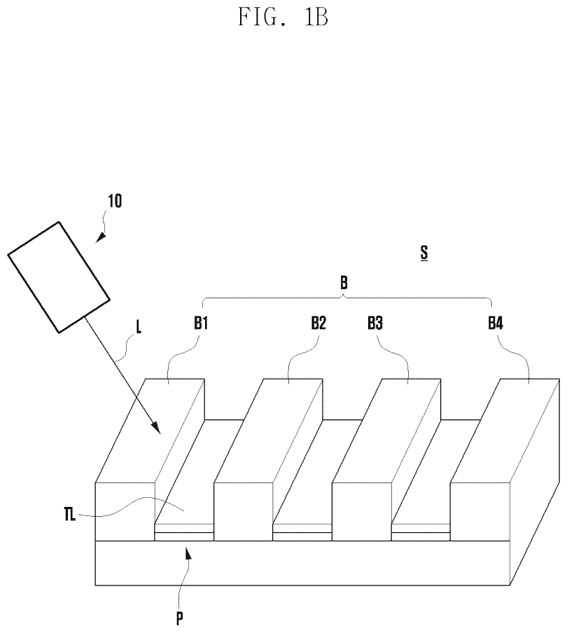

### DETAILED DESCRIPTION

Hereinafter, a wavelength scan type display inspection apparatus according to embodiments of the disclosure will be described in detail with reference to the attached drawings.

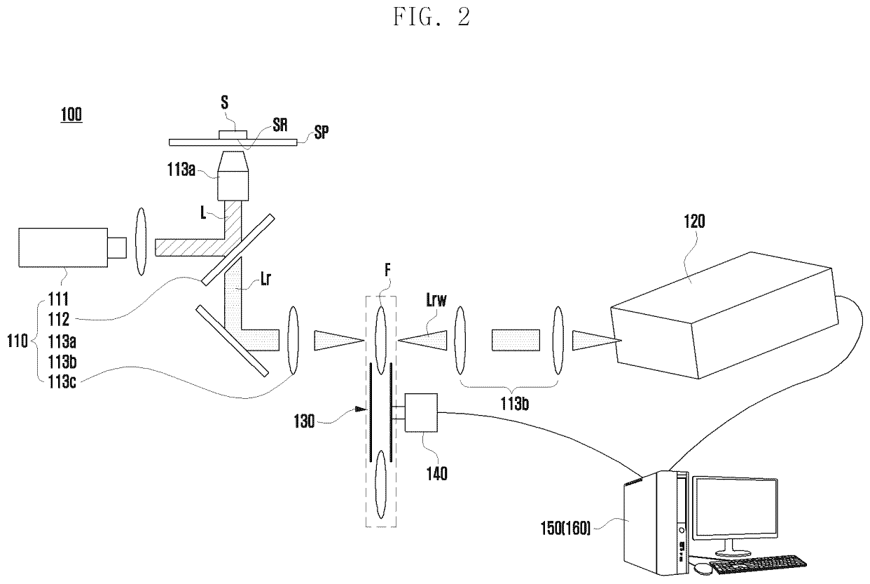

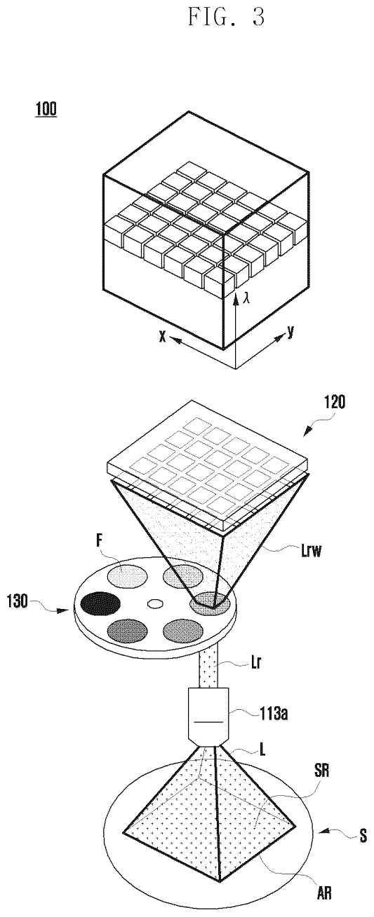

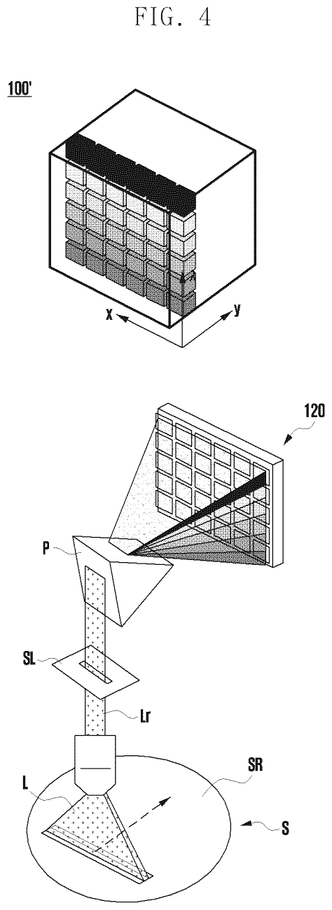

FIG. 2 is a front view of a wavelength scan type display inspection apparatus according to an embodiment of the disclosure, FIG. 3 is a conceptual diagram illustrating a wavelength scan type display inspection apparatus according to an embodiment of the disclosure, and FIG. 4 is a conceptual diagram illustrating a line scan type display inspection apparatus according to a comparative example.

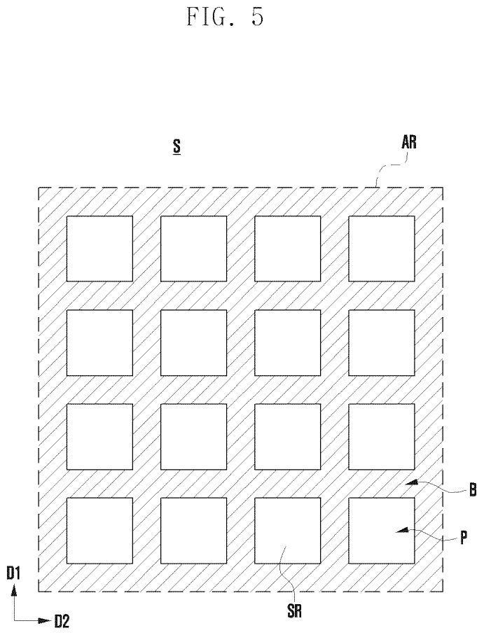

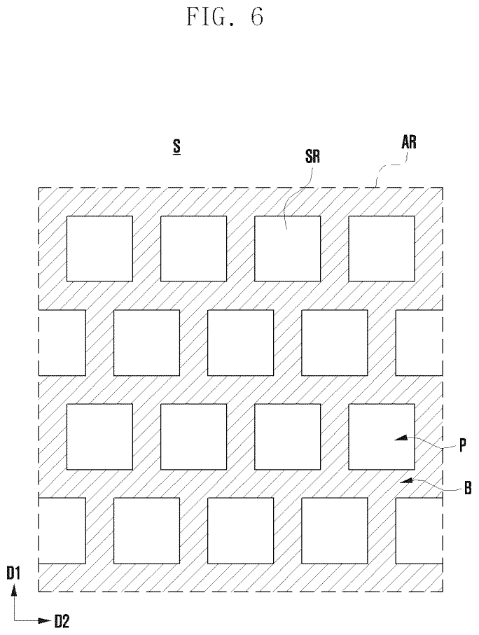

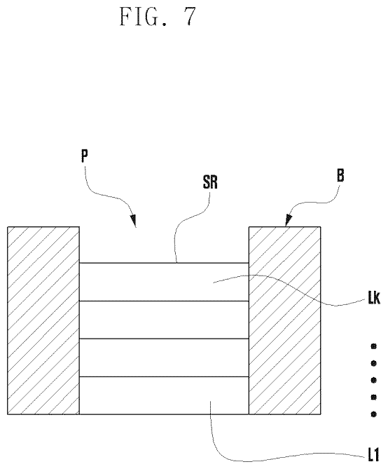

FIGS. 5 and 6 are plan views illustrating a two-dimensional area of a display sample, and FIG. 7 is a cross-sectional view of a pixel of a display sample.

With reference to FIGS. 2 to 6, a wavelength scan type display inspection apparatus 100 according to an embodiment of the disclosure will be described hereinafter.

The wavelength scan type display inspection apparatus 100 includes a display sample S, a light irradiator 110, a filter wheel 130, a driver 140, a spectrometer 120, and a controller 150. The wavelength scan type display inspection apparatus 100 may further include a storage 160.

The display sample S has one or more layers L1 to Lk (see FIG. 7; also referred to as “thin film” hereinafter). The one or more layers L1 to Lk may have a number of 1 or more and 10 or less. The display sample S may include one or more of OLED and QLED.

The light irradiator 110 irradiates light L to the display sample S so that the light L is incident onto a two-dimensional area AR of the surface SR of the display sample S.

For example, with reference to FIGS. 5 and 6, the two-dimensional area AR may refer to “an area in which a plurality of pixels P are arranged along a first direction D1 and a plurality of pixels P are arranged along a second direction D2 orthogonal to the first direction D1”. The meaning of “a plurality of pixels P being arranged along the first direction D1” may include not only the case where “pixels P adjacent to each other along the first direction D1 are arranged in a row” as shown in FIG. 5, but also the case where “pixels P facing each other with a series of other pixels P interposed along the first direction D1 are arranged in a row” as shown in FIG. 6. Similarly, the meaning of “a plurality of pixels P being arranged along the second direction D2” may include not only the case where “pixels P adjacent to each other along the second direction D2 are arranged in a row”, but also the case where “pixels P facing each other with a series of other pixels P interposed along the second direction D2 are arranged in a row”.

In the description, the “pixel P” may refer to “a portion corresponding to one or more layers L1 to Lk surrounded by a partition wall B when viewed in a direction perpendicular to the surface SR of the display sample S”. Each pixel P can emit light corresponding to one of red, green, and blue colors.

For example, as shown in FIG. 2, the surface SR of the display sample S may be supported by a support SP. This support SP may be a glass substrate.

The support SP supports the entire surface SR of the display sample S, and light L can be irradiated onto the surface SR of the display sample S through the support SP. Alternatively, the support SP may support only an edge of the surface SR of the display sample S, and light L can be directly irradiated onto the remaining portion of the surface SR of the display sample S excluding the edge. Of course, as illustrated in FIG. 3, light L may be irradiated onto the surface SR of the display sample S opposite the support SP.

The light irradiator 110 may include a light source 111, a beam splitter 112, and a first lens 113a. The light irradiator 110 may further include at least one of a second lens 113b and a third lens 113c. The light source 111 generates light L. The beam splitter 112 reflects the light L emitted from the light source 111 toward the display sample S. The first lens 113a focuses the light L reflected from the beam splitter 112 to be incident onto the surface SR of the display sample S. The second lens 113b focuses the wavelength-reflected light Lrw to be incident onto the spectrometer 120.

The filter wheel 130 is a wheel having a plurality of filters F. The plurality of filters F each convert the reflected light Lr reflected from the display sample S into the corresponding wavelength-reflected light Lrw.

The driver 140 rotates the filter wheel 130. For example, the driver 140 may be implemented by a motor.

The spectrometer 120 measures a spectrum for the wavelength-reflected light Lrw. For example, the spectrometer 120 can measure a spectrum for the wavelength-reflected light Lrw included in the ultraviolet range to the visible light range. For example, the spectrometer 120 can measure a spectrum for the wavelength-reflected light Lrw included in the wavelength range of 100 nm to 1000 nm. The spectrometer 120 may be implemented with a Charge-Coupled Device (CCD) or Complementary Metal-Oxide Semiconductor (CMOS) camera.

The controller 150 controls the driver 140 to change the filter F through which the reflected light Lr passes. The controller 150 determines the thickness of each of one or more layers L1 to Lk, based on the spectrum for a two-dimensional area AR spanning a plurality of wavelengths according to the change in the filter F. The plurality of wavelengths may have a number between 2 and 20.

The controller 150 can determine the thickness of each of one or more layers L1 to Lk by using artificial intelligence (AI). The AI may include one or more of random forest, Gaussian process regression, and deep learning neural network.

The storage 160 can store an AI model (AI program).

With reference to FIG. 4, the line scan type display inspection apparatus 100′ according to a comparative example acquires reflectance information for a line (one-dimension) through a slit SL and then spectroscopes it using a prism P or a grating. Through this, as shown in an upper part of FIG. 4, information about the wavelength along the λ-axis and the actual x values along the x-axis is acquired. To acqurie information about the y-axis (to expand from one-dimension to two-dimension), the display sample S needs to be moved in the y-axis direction, i.e., scanned. In this process, an information acquisition speed relies on a scan speed, so the information acquisition speed is mostly slow.

In contrast, the wavelength scan type display inspection apparatus 100 according to an embodiment of the disclosure includes the filter wheel 130 having the plurality of filters F that convert the reflected light Lr into the wavelength-reflected light Lrw of the corresponding wavelength. When the filter wheel 130 is rotated, the reflectance can be measured with the wavelength of the corresponding filter F. That is, with regard to the wavelength-reflected light Lrw converted from the reflected light Lr, the number of wavelengths is determined by the number of filters F. Therefore, the wavelength scan type display inspection apparatus 100 has a reduced amount of spectral information because spectrum is not continuous contrary to that of the line scan type. In addition, compared to the line scan type, the wavelength scan type display inspection apparatus 100 only requires the rotation of the filter wheel 130 to measure, thus acquiring spectral information much faster for a large two-dimensional area AR.

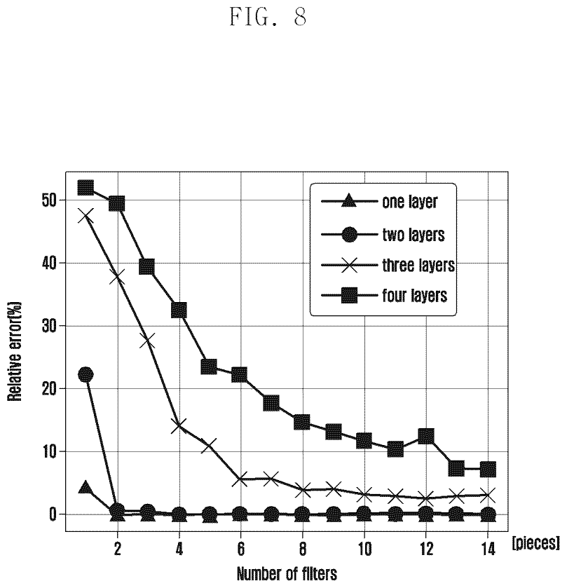

FIG. 8 is a graph showing the relationship between the number of filters and a relative error for a simulation of measuring the thickness of each layer of a display sample by a wavelength scan type display inspection apparatus according to an embodiment of the disclosure.

In this regard, it was assumed that a first layer L1 of the display sample S was a ZnO layer having a refractive index of 2, a second layer L2 was a quantum dot layer having a refractive index of 2.7, a third layer L3 was a TCTA (4,4′,4″-Tris(Carbazol-9-yl)-TriphenylAmine) layer having a refractive index of 1.7, and a fourth layer L4 was a MoO₃ layer having a refractive index of 2.5. Additionally, the thickness of each layer was assumed to be random, ranging from 10 nm to 70 nm. For simulation, the reflectance was calculated for 10,000 stacks (display samples S) having different stack numbers and different thicknesses. Data of the calculated reflectance were used to train a random forest. Using the trained random forest, a simulation was performed to measure each layer thickness of 100 new display samples S.

In this regard, it was assumed that the filter wheel 130 has a total of three filters, that is, a filter F for conversion into wavelength-reflected light Lrw of 230 nm wavelength, a filter F for conversion into wavelength-reflected light Lrw of 260 nm wavelength, and a filter F for conversion into wavelength-reflected light Lrw of 290 nm wavelength. In addition, the number of estimators (hereinafter also referred to as “parameters”) used in the random forest was 300.

Additionally, the relative error was calculated using Equation 1 below.

$$E = \sum \frac{1}{N} \times \frac{\sqrt{{( Y - {Y}_{pred} )}^{2}}}{Y} \qquad [ Equation 1 ]$$

In Equation 1, N is the total number of layers L1 to Lk whose thicknesses are predicted, Y is the actual thickness of each of layers L1 to Lk, Y_{pred} is the predicted thickness of each of layers L1 to Lk, and E is the relative error.

As can be seen from FIG. 8, in the case of a display sample S having one layer or having two layers, a relative error of about 1% is achieved even when only two filters F are used. In the case of a display sample S having three layers, a relative error of 3% or less is achieved when 11 or more filters F are used. In the case of a display sample S having four layers, a relative error that converges to a level of 6% is achieved when 13 or more filters F are used.

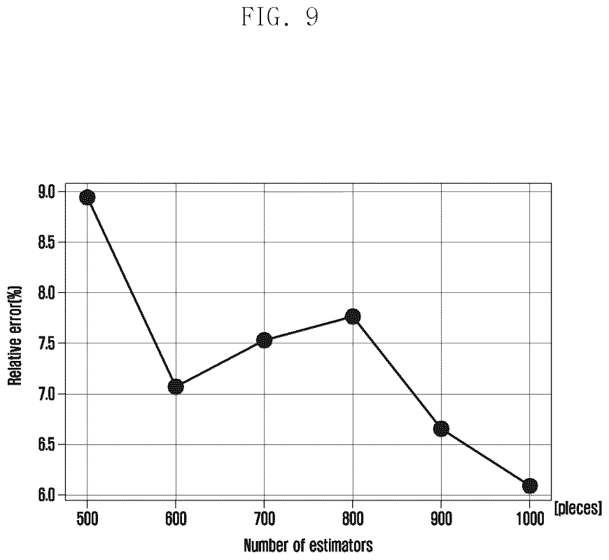

FIG. 9 is a graph showing the relationship between the number of estimators and a relative error for a simulation of measuring the thickness of each layer of a display sample by a wavelength scan type display inspection apparatus according to an embodiment of the disclosure.

In this regard, it was assumed that the filter wheel 130 has 15 filters F for conversion into wavelength-reflected lights Lrw of 15 pieces of wavelength at intervals of 30 nm from 230 nm. In addition, a simulation was conducted to calculate the relative error while changing the number of estimators of the random forest.

As can be seen from FIG. 8, the prediction becomes more inaccurate as the number of layers increases, but as can be seen from FIG. 9, the relative error tends to decrease as the number of estimators increases. That is, by setting the number of estimators of AI such as, for example, the random forest according to the layer stack number of one or more layers L1 to Lk of the display sample S, the thickness of each of layers L1 to Lk of the display sample S with various layer stack numbers can be quickly predicted with a minimized relative error.

According to the first feature of embodiments of the disclosure, a display inspection apparatus 100 of a wavelength scan type may include a display sample S having one or more layers L1 to Lk; a light irradiator 110 irradiating light L to the display sample S so that the light L is incident onto a two-dimensional area AR of a surface SR of the display sample S; a filter wheel 130 having a plurality of filters F, each filter converting reflected light Lr reflected from the display sample S into wavelength-reflected light Lrw of a corresponding wavelength; a driver 140 rotating the filter wheel 130; a spectrometer 120 measuring a spectrum for the wavelength-reflected light Lrw; and a controller 150 controlling the driver 140 to change the filter F through which the reflected light Lr passes, and determining a thickness of each of the one or more layers L1 to Lk based on the spectrum for the two-dimensional area AR over a plurality of wavelengths according to the change of the filter F. Accordingly, the thickness of the thin film of the display sample S can be measured in a nanometer level in a short time. In addition, the thickness of each layer of OLED and QLED devices manufactured by inkjet printing can be predicted with a single measurement, and it is possible to determine defects due to thickness unevenness and improve the defects through related feedback.

In the apparatus 100 according to the first feature, the controller 150 may determine the thickness of each of the one or more layers L1 to Lk by using artificial intelligence. Also, in the apparatus 100 according to the first feature, the artificial intelligence may include one or more of random forest, Gaussian process regression, and deep learning neural network. Accordingly, the measurement time can be reduced, and the prediction error for the thickness of each layer can be minimized.

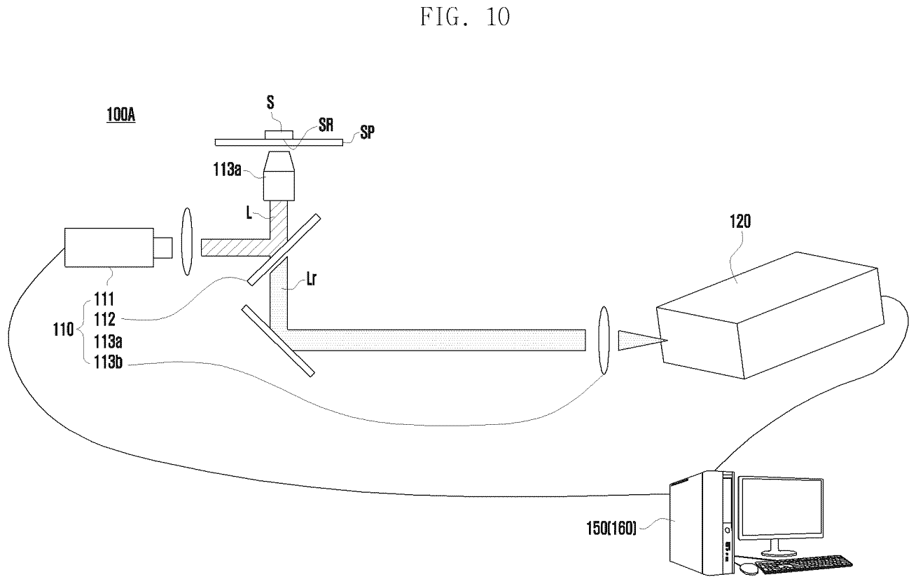

FIG. 10 is a front view of a wavelength scan type display inspection apparatus according to a modified embodiment of the disclosure.

With reference to FIG. 10 together with FIGS. 5 to 7, the wavelength scan type display inspection apparatus 100A according to a modified embodiment includes the display sample S, the light irradiator 110, the spectrometer 120, and the controller 150. The wavelength scan type display inspection apparatus 100A according to a modified embodiment may further include the storage 160.

Compared to the wavelength scan type display inspection apparatus 100 shown in FIG. 2, the wavelength scan type display inspection apparatus 100A according to a modified embodiment is different in that it does not include the filter wheel 130 and the driver 140, and the light irradiator 110 includes a light source 111 capable of changing the wavelength of light L, and the related operation of the controller 150.

The display sample S has one or more layers L1 to Lk. The one or more layers L1 to Lk may have a number of 1 or more and 10 or less. The display sample S may include one or more of OLED and QLED.

The light irradiator 110 irradiates light L to the display sample S so that the light L is incident onto a two-dimensional area AR of the surface SR of the display sample S.

The light irradiator 110 includes the light source 111 that generates light L. The light irradiator 110 may further include the beam splitter 112 and the first lens 113a. The light irradiator 110 may further include the second lens 113b. The beam splitter 112 reflects the light L emitted from the light source 111 toward the display sample S. The first lens 113a focuses the light L reflected from the beam splitter 112 to be incident onto the surface SR of the display sample S. The second lens 113b focuses the reflected light Lr to be incident onto the spectrometer 120.

The spectrometer 120 measures a spectrum for the reflected light Lr reflected from the display sample S.

The controller 150 controls the light source 111 to change the wavelength of the light L. The controller 150 determines the thickness of each of one or more layers L1 to Lk, based on the spectrum for a two-dimensional area AR over a plurality of wavelengths according to the change in the wavelength of the light L. The plurality of wavelengths may have a number of 2 or more and 20 or less.

The controller 150 can determine the thickness of each of one or more layers L1 to Lk by using AI. The AI may include one or more of random forest, Gaussian process regression, and deep learning neural network.

The storage 160 can store an AI model (AI program).

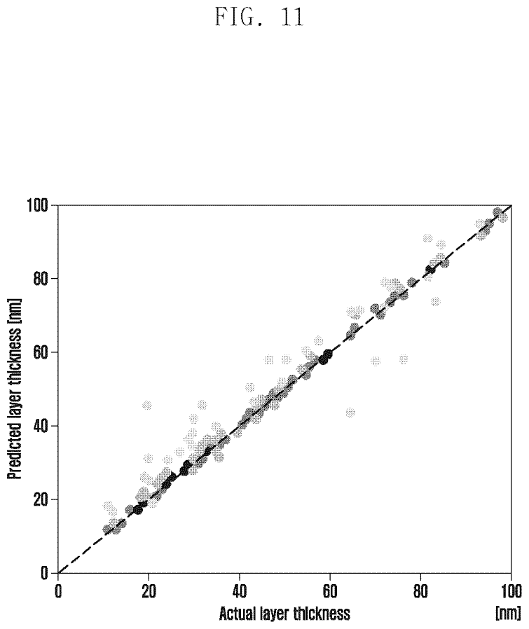

FIG. 11 is a graph showing the relationship between an actual layer thickness and a predicted layer thickness for the results of actually inspecting the layer thickness of a display sample having a single layer by a wavelength scan type display inspection apparatus according to a modified embodiment of the disclosure.

In this regard, as the light source 111 of the wavelength scan type display inspection apparatus 100A according to a modified embodiment, a multi-LED light source (model name pE-4000) from CoolLED was used. 1,250 display samples S having a single ZnO layer of various thicknesses were prepared. The light source 111 sequentially emitted light L of 365 nm, 385 nm, 405 nm, 435 nm, 460 nm, 470 nm, 490 nm, 500 nm, 525 nm, and 550 nm, i.e., a total of 10 wavelengths. After learning with a random forest using some of the 1,250 display samples S, the thickness of the ZnO layer was actually inspected (predicted) for the remainder of the 1,250 display samples S.

In FIG. 11, the darker the circle, the higher the frequency. As can be seen from FIG. 11, the actual layer thickness and the predicted layer thickness were generally consistent, and it was confirmed that they had an error of approximately 3%.

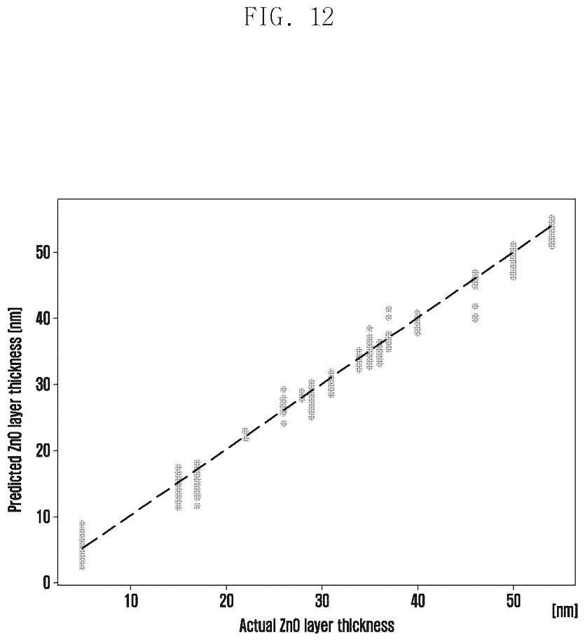

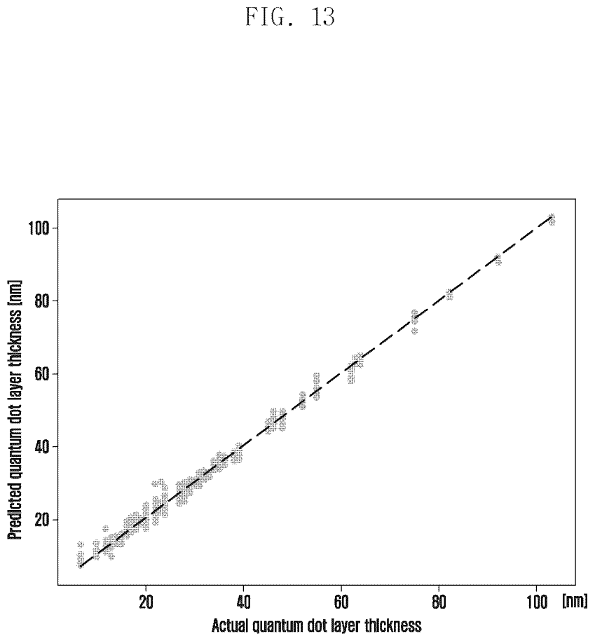

FIGS. 12 and 13 are graphs showing the relationship between an actual layer thickness and a predicted layer thickness for the results of actually inspecting each layer thickness of a display sample having two layers by a wavelength scan type display inspection apparatus according to a modified embodiment of the disclosure.

In this regard, as the light source 111 of the wavelength scan type display inspection apparatus 100A according to a modified embodiment, a multi-LED light source (model name pE-4000) from coolLED was used. 185 two-layer display samples S in which a ZnO layer and a quantum dot layer were sequentially stacked were prepared, and the thickness of each of the ZnO layer and the quantum dot layer was inspected (predicted).

As can be seen from FIGS. 12 and 13, it was confirmed that the thicknesses of the ZnO layer and the quantum dot layer were predicted with an error of less than 10%.

According to the second feature of embodiments of the disclosure, a display inspection apparatus 100A of a wavelength scan type may include a display sample S having one or more layers L1 to Lk; a light irradiator 110 irradiating light L to the display sample S so that the light L is incident onto a two-dimensional area AR of a surface of the display sample S, and including a light source 111 generating the light L; a spectrometer 120 measuring a spectrum for reflected light Lr reflected from the display sample S; and a controller 150 controlling the light source 111 to change a wavelength of the light L, and determining a thickness of each of the one or more layers L1 to Lk based on the spectrum for the two-dimensional area AR over a plurality of wavelengths according to the change in the wavelength of the light L.

In the apparatus 100A according to the second feature, the controller 150 may determine the thickness of each of the one or more layers L1 to Lk by using artificial intelligence. Also, in the apparatus 100A according to the second feature, the artificial intelligence may include one or more of random forest, Gaussian process regression, and deep learning neural network.

While the disclosure has been particularly shown and described with reference to an exemplary embodiment thereof, it will be understood by those skilled in the art that various changes in form and details may be made therein without departing from the scope of the disclosure as defined by the appended claims.

What is claimed is:

1. A display inspection apparatus of a wavelength scan type, comprising:
a display sample having one or more layers;
a light irradiator irradiating light to the display sample so that the light is incident onto a two-dimensional area of a surface of the display sample;
a filter wheel having a plurality of filters, each filter converting reflected light reflected from the display sample into wavelength-reflected light with a corresponding wavelength;
a driver rotating the filter wheel;
a spectrometer measuring a spectrum for the wavelength-reflected light; and
a controller controlling the driver to change the filter through which the reflected light passes, and determining a thickness of each of the one or more layers based on the spectrum for the two-dimensional area over a plurality of wavelengths according to the change of the filter.

2. The apparatus of claim 1, wherein the controller determines the thickness of each of the one or more layers by using artificial intelligence.

3. The apparatus of claim 2, wherein the artificial intelligence includes one or more of random forest, Gaussian process regression, and deep learning neural network.

4. The apparatus of claim 1, wherein the plurality of wavelengths has a number of 2 or more and 20 or less.

5. The apparatus of claim 1, wherein the one or more layers has a number of 1 or more and 10 or less.

6. The apparatus of claim 1, wherein the light irradiator includes:
a light source generating the light;
a beam splitter reflecting the light emitted from the light source toward the display sample; and
a first lens focusing the light reflected from the beam splitter to be incident onto the surface of the display sample.

7. The apparatus of claim 6, wherein the light irradiator further includes a second lens focusing the wavelength-reflected light to be incident onto the spectrometer.

8. The apparatus of claim 1, wherein the display sample includes at least one of an Organic Light Emitting Diode (OLED) and a Quantum dot Light Emitting Diode (QLED).

9. A display inspection apparatus of a wavelength scan type, comprising:
a display sample having one or more layers;
a light irradiator irradiating light to the display sample so that the light is incident onto a two-dimensional area of a surface of the display sample, and including a light source generating the light;
a spectrometer measuring a spectrum for reflected light reflected from the display sample; and
a controller controlling the light source to change a wavelength of the light, and determining a thickness of each of the one or more layers based on the spectrum for the two-dimensional area over a plurality of wavelengths according to the change in the wavelength of the light.

10. The apparatus of claim 9, wherein the controller determines the thickness of each of the one or more layers by using artificial intelligence.

11. The apparatus of claim 10, wherein the artificial intelligence includes one or more of random forest, Gaussian process regression, and deep learning neural network.

12. The apparatus of claim 9, wherein the plurality of wavelengths has a number of 2 or more and 20 or less.

13. The apparatus of claim 9, wherein the one or more layers has a number of 1 or more and 10 or less.

14. The apparatus of claim 9, wherein the light irradiator further includes:
a beam splitter reflecting the light emitted from the light source toward the display sample; and
a first lens focusing the light reflected from the beam splitter to be incident onto the surface of the display sample.

15. The apparatus of claim 14, wherein the light irradiator further includes a second lens focusing the reflected light to be incident onto the spectrometer.

16. The apparatus of claim 9, wherein the display sample includes at least one of an Organic Light Emitting Diode (OLED) and a Quantum dot Light Emitting Diode (QLED).
